(19) United States
(12) Patent Application Publication
(10) Pub. No.: US 2009/0150437 A1
(43) Pub. Date: Jun. 11, 2009

(54) System and method for tracking an individual using typeprinting

(76) Inventors: Gustavo De Los Reyes, Fair Haven, NJ (US); Sanjay Macwan, Marlboro, NJ (US)

Correspondence Address: AT & T Legal Department - WS;Attn: Patent Docketing, Room 2A-207, One AT & T Way, Bedminster, NJ, 07921, US

(21) Appl. No.: 11/999,850

(22) Filed: Dec. 7, 2007

(51) Int. Cl. G06F 17/00

(52) U.S. Cl. 707/104.1; 707/E17.009

(57) ABSTRACT

Disclosed is a system and method for tracking an individual of interest over a network. Keystroke dynamics of users using computers are obtained in order to identify the individual of interest when the individual of interest uses one of the computers. Usage data of the individual of interest is recorded when the individual of interest is identified as using one of the computers.

### BACKGROUND OF THE INVENTION

The present invention is generally directed to typeprinting, and more specifically to tracking an individual over a network using typeprinting.

Activity, such as criminal or fraudulent activity, conducted using the Internet (i.e., on-line activity) is often difficult to trace. Users may hide their identity by changing which machine or on-line software application they use. Examples of on-line software applications include Instant Messenger (IM), web browsing, or any other software application that communicates via a web session with another computer. Users may also hide their identity by using anonymizers, which are software tools that attempt to hide a source computer's identifying information.

One technique used to track an individual conducting activities on-line is by using Internet Protocol (IP) addresses. An IP address is a unique address that certain electronic devices (e.g., computers) use in order to identify themselves and communicate with each other on a computer network. The IP address of a device is typically assigned to that device by an Internet Service Provider (ISP).

Using an IP address to track an individual, however, has several drawbacks. First, the IP address is associated with a device and not an individual. As a result, an ISP tracking an individual may have to assume that the individual being tracked is the person actually using the device with the tracked IP address. This assumption is often incorrect, as an individual's family or friends may use the tracked device rather than the individual himself. If this occurs, then the ISP may be tracking the correct device (IP address) but the incorrect individual. Second, if the individual uses more than one device, such as using his home-computer as well as a computer at a library to perform on-line activities, it is often extremely difficult, and may be virtually impossible, to track the individual at all times.

Therefore, there remains a need for an improved technique for tracking an individual over a network.

### BRIEF SUMMARY OF THE INVENTION

In accordance with an embodiment of the present invention, an individual of interest is tracked over a network. Keystroke dynamics of users using computers are obtained. A typeprint for each user is generated and compared with a stored typeprint of individuals of interest. Usage data of a user is recorded when the typeprint of the user matches the stored typeprint of an individual of interest.

The usage data recorded may be of any nature or type. For example, the usage data may include the date and/or time on which the user logged into the computer and/or logged off of the computer.

The typeprint of one or more individuals of interest may be generated and/or stored before obtaining the keystroke dynamics of other users. In one embodiment, one physical characteristics of the individual of interest may also be obtained and stored with the typeprint, such as an individual's fingerprint, retina/iris image, and/or voiceprint. In one embodiment, an individual's username and/or password is obtained and stored with the typeprint. When the typeprint of a user is compared with a typeprint of an individual of interest, these other characteristics may also be compared and used in the determination as to whether the user is the individual of interest.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a computer system having a server in communication with client devices over a network in accordance with an embodiment of the present invention;

FIG. 2 is a flowchart illustrating the steps performed by the server to track an individual of interest in accordance with an embodiment of the present invention; and

FIG. 3 is a high level block diagram of a computer implementation of a server in accordance with an embodiment of the present invention.

### DETAILED DESCRIPTION

Like fingerprinting, typeprinting can be used to identify an individual. Typeprinting (also referred to as biometric typeprinting) is determining an individual's keystroke dynamics to establish an identity for the individual. An individual's keystroke dynamics, or the typing characteristics of an individual typing a passage of text, can typically identify the individual. Unlike static physical characteristic such as fingerprints or iris scans, keystroke dynamics relate to the individual's actions over time. Specifically, keystroke dynamics is the detailed timing information that describes exactly when each key was depressed and when it was released as a person is typing at a computer keyboard. Keystroke dynamics include keystroke timing or keypad press rhythms. Keystroke dynamics may also include the pressure at which a key is pressed.

In more detail, keystroke dynamics may measure a series of key down and key up event timings for characters while a user types a string. These raw measurements can be recorded from almost any keyboard or keypad to determine dwell time (the time between key down and key up) and flight time (the time from “key down” to the next “key down” to the time between one “key up” and the next “key up”). Once the keystroke timing data is captured, the recorded keystroke timing data is then processed and a pattern is determined. This pattern, or typeprint, can be used to identify the individual who typed the string.

One existing use of keystroke dynamics is authentication of an individual logging into a system. Anyone who has individual A's login name and password can log into a computer system as individual A, even if the person attempting the login is not individual A. Keystroke dynamics are currently used to authenticate the individual logging in as individual A to ensure that the individual is, in fact, individual A.

Keystroke dynamics have not, however, been used to track an individual of interest. An individual of interest is someone who has caught the attention of one or more law enforcement agencies, a child, an employee, a spouse, a customer, or any designated individual. Unlike the previous tracking techniques using an IP address to track a device, the individual of interest is tracked across multiple computers in accordance with an embodiment of the present invention.

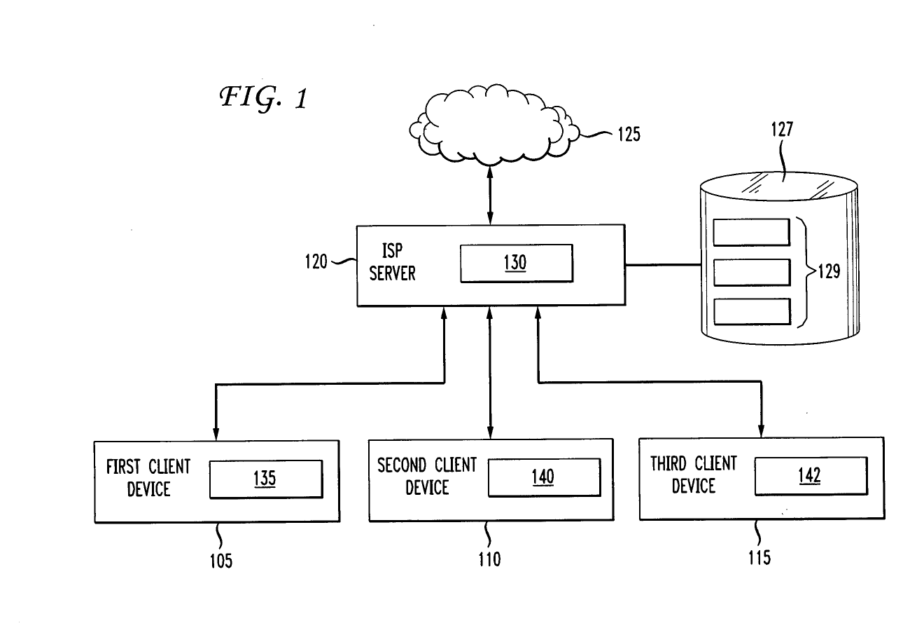

FIG. 1 is a block diagram of a system 100 having a first client device 105, a second client device 110, and a third client device 115 communicating with an Internet Service Provider (ISP) server 120 before communicating over network 125. The client devices 105, 110, 115 are any computing devices (e.g., laptop computer, desktop computer, smart phone, etc.) that include a keyboard or keypad and can communicate with another computing device over network 125. Communications by a client device 105, 110, 115 over network 125 can include, for example, email, instant messaging, or web browsing. Although system 100 is shown with three client devices 105, 110, 115, any number of client devices may be communicating with server 120.

In one embodiment, the server 120 is an ISP server that enables the client devices 105, 110, 115 to connect to the network 125. The server 120 may alternatively be a router, a switch, etc. Although system 100 has one server 120, any number of servers may be present in the system 100 (e.g., two different servers owned by two different ISPs).

The server 120 communicates with a database 127. Typeprints 129 associated with individuals of interest are stored in the database 127. These stored typeprints 129 may be generated and stored by a typeprint generation module 130 executing on the server 120 or may be obtained from, for example, one or more law enforcement agencies. Once typeprints 129 associated with one or more individual of interest have been stored in database 127, the individuals of interest can be tracked across multiple computers. Although shown with one database 127, the server 120 may communicate with any number of databases.

The typeprint generation module 130 collects keystroke dynamics for users who use one or more of the client devices 105, 110, 115. Users may use one or more of the client devices 105,110, 115 to access the Internet via the server 120. The keystroke dynamics are used to generate typeprints for the users of the client devices 105, 110, 115. These typeprints are compared with the typeprints 129 for the individuals of interest stored in the database 127 to determine whether a user is an individual of interest. As described in more detail below, if a typeprint generated for a particular user matches a typeprint stored in the database 127, the user is an individual of interest and data corresponding to the usage of the client device being used by the user (i.e., usage data) is recorded (e.g., in the same database 127 or another database).

For example, a first individual may be connected to the World Wide Web (web) using a browser 135 on the first client device 105 and a second individual may be connected to the web using a browser 140 on the second client device 110. The third client device 115 may also have a browser 142. In one embodiment, the web pages are being accessed by the browsers 135,140 (and 142).

The web browser 135, 140 (and 142) transmits the collected keystroke dynamics back to the typeprint generation module 130 for analysis. The typeprint generation module 130 analyzes the keystroke dynamics to obtain a typeprint for each individual using one of the client devices 105, 110, 115.

The typeprint generation module 130 may generate a typeprint for the first individual using the first client device 105. This typeprint is compared against the typeprints 129 stored in the database 127. If a match is found, the user can be identified as an individual of interest and usage data associated with the first individual's use of the first client device 105 can be recorded. At some later point in time, the first individual may use the third client device 115. The typeprint generation module 130 again generates a typeprint for the first individual using the third client device 115. This typeprint is compared against the typeprints 129 stored in the database 127. When a match is found, the first individual is again identified as the individual of interest and usage data associated with the first individual's use of the third client device 115 is recorded in database 127. Thus, unlike the current techniques of tracking an individual of interest via an IP address of a machine that the individual often uses, the typeprint generation module 130 can track the individual of interest no matter what machine the individual of interest uses.

In another embodiment, the typeprint generation module is a module executing on one or more client devices 105,110, 115. For example, the server 120 can download a typeprint generation module to the first client device 105. In this embodiment, the client device 105 can generate typeprints even when the individual does not create an on-line communication session via the server 120 (e.g., does not access a web page or an on-line service such as IM). For example, a typeprint generation module on the first client device 105 can generate a typeprint of an individual from an email message generated by the individual as the individual is typing the email on the first client device 105. The typeprint can then be transmitted to the server 120 for analysis.

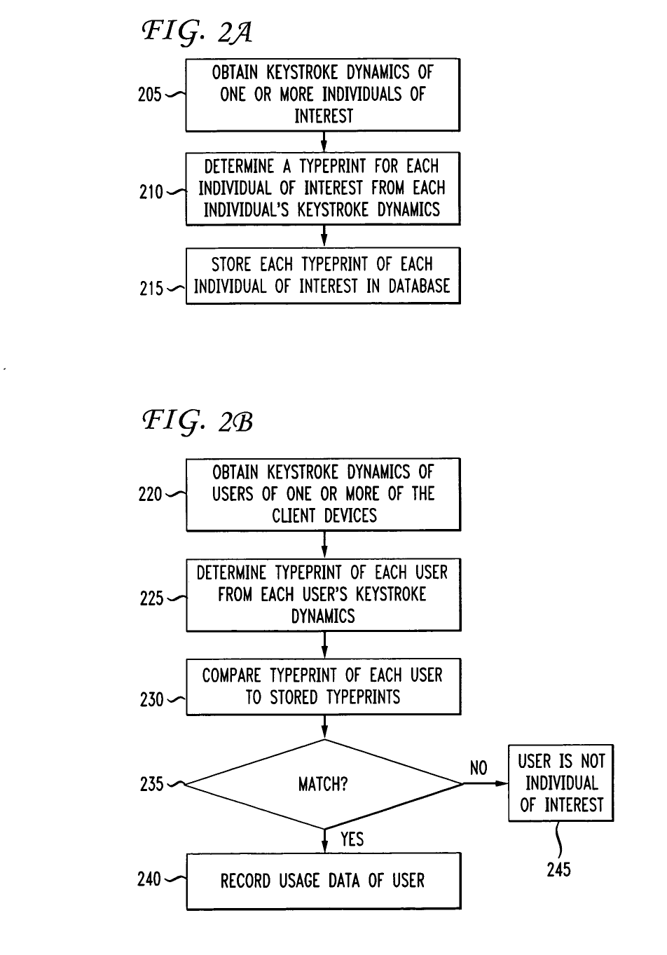

FIG. 2A shows a flowchart illustrating the steps performed by the server 120 (or a client device) to store the typeprints of individuals of interest in database 127. The server 120 obtains the keystroke dynamics of one or more individuals of interest in step 205. The server 120 then determines a typeprint for each individual of interest from each individual's keystroke dynamics in step 210. The server 120 then stores the typeprint of each individual of interest in database 127 in step 215.

FIG. 2B shows a flowchart illustrating the steps performed by the server 120 (or a client device) to track an individual of interest. The server 120 obtains keystroke dynamics of users of one or more of the client devices 105, 110, 115 in step 220. The keystroke dynamics can be obtained any time a user is using the client device 105, 110, 115 (e.g., at the start of an on-line session (e.g., during logon), during an on-line session (e.g., after logon), at the end of an on-line session (e.g., before logging off), or when the user is using the client device 105, 110, 115 off-line (e.g., if software is downloaded to the client device 105, 110, 115)).

From the keystroke dynamics, a typeprint is generated for each user of the client devices 105, 110, 115 in step 225. The server 120 then compares the generated typeprint of each user to the stored typeprints associated with individuals of interest in step 230. The server 120 then determines in step 235 if there is a match between the generated typeprint and any of the stored typeprints.

Biometric measurements such as keystroke dynamics of a person may vary slightly from time to time because the measurement resolution required to reliably distinguish between different people is high enough to also detect differences between two measurements of the same person. For example, an iris or retina image is unlikely to be pixel-for-pixel identical to an earlier-taken image, and a typing-rhythm measurement with, for example, 5 ms resolution is unlikely to match an earlier sample exactly. Therefore, biometric validation is usually a loose comparison process that often produces an output called a “biometric score.” The output may represent a probability that the user whose features (e.g., keystroke dynamics) were measured is the same as the individual of interest whose information was stored in the database 127. The server 120 may set a threshold value for this probability, so that typeprint comparisons yielding a biometric score over a predetermined or configurable threshold are considered to be successful.

In one embodiment, the server 120 identifies a user as an individual of interest if the user's typeprint matches a stored typeprint and other characteristics also match. These characteristics may include physical characteristics such as a fingerprint, a voiceprint, and/or an iris or retinal scan. The client device 105, 110, 115 that the user is using may include additional hardware to enable the client device 105, 110, 115 to transmit these physical characteristics about the user to the server 120, such as a fingerprint scanner, a microphone (to obtain a voiceprint), or an iris/retina scanner. These characteristics may also include a user's username and/or password.

If there is a match in step 235, usage data of the user is recorded in step 240. As described above, this usage data may include the date and/or time when the user logged into the client device and/or when the user logged off of the client device. If the typeprints do not match for a particular user, the user is not an individual of interest (step 245) and no usage data is recorded for that user.

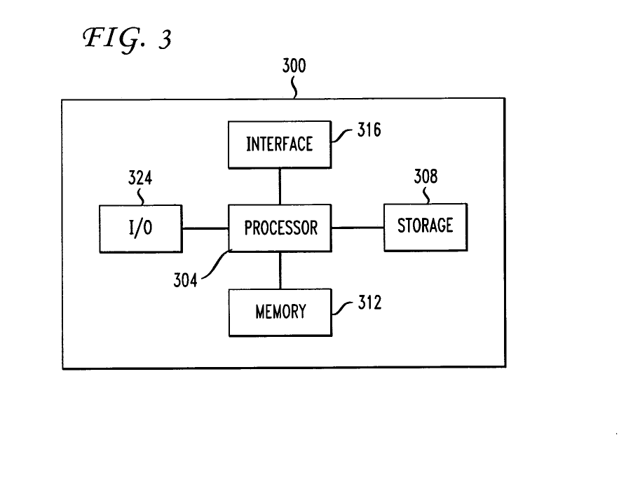

FIG. 3 shows a high level block diagram of a computer 300 which may be used to implement the server 120 and/or client devices 105, 110, 115. The computer 300 can, for example, perform the steps described above (e.g., with respect to FIG. 2). Computer 300 contains a processor 304 which controls the overall operation of the computer by executing computer program instructions which define such operation. The computer program instructions may be stored in a storage device 308 (e.g., magnetic disk, database) and loaded into memory 312 when execution of the computer program instructions is desired. Thus, the computer operation will be defined by computer program instructions stored in memory 312 and/or storage 308 and the computer will be controlled by processor 304 executing the computer program instructions. Computer 300 also includes one or more interfaces 316 for communicating with other devices. Computer 300 also includes input/output 324 which represents devices which allow for user interaction with the computer 300 (e.g., display, keyboard, mouse, speakers, buttons, etc.). One skilled in the art will recognize that an implementation of an actual computer will contain other components as well, and that FIG. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for tracking an individual of interest over a network comprising:
obtaining keystroke dynamics of users using a plurality of computers;
generating a typeprint for each of said users;
comparing said typeprint for each of said users to stored typeprints of individuals of interest; and
recording usage data of a user when the typeprint of said user matches a stored typeprint of an individual of interest.

2. The method of claim 1 further comprising storing a typeprint for said individual of interest.

3. The method of claim 1 wherein said recording usage data further comprises storing data related to when said individual of interest logs onto a computer and when said individual of interest logs off of said computer.

4. The method of claim 1 further comprising obtaining at least one physical characteristic of said user.

5. The method of claim 4 further comprising comparing said at least one physical characteristic with at least one stored physical characteristic.

6. A system for tracking an individual of interest over a network comprising:
means for obtaining keystroke dynamics of users using a plurality of computers;
means for generating a typeprint for each of said users;
means for comparing said typeprint for each of said users to stored typeprints of individuals of interest; and
means for recording usage data of a user when the typeprint of said user matches a stored typeprint of an individual of interest.

7. The system of claim 6 further comprising means for storing a typeprint for said individual of interest.

8. The system of claim 6 wherein said means for recording usage data further comprises means for storing data related to when said individual of interest logs onto a computer and when said individual of interest logs off of said computer.

9. The system of claim 6 further comprising means for obtaining at least one physical characteristic of said user.

10. The system of claim 9 further comprising means for comparing said at least one physical characteristic with at least one stored physical characteristic.

11. A computer readable medium comprising computer program instructions capable of being executed in a processor and defining the steps comprising:
obtaining keystroke dynamics of users using a plurality of computers;
generating a typeprint for each of said users;
comparing said typeprint for each of said users to stored typeprints of individuals of interest; and
recording usage data of a user when the typeprint of said user matches a stored typeprint of an individual of interest.

12. The computer readable medium of claim 11 further comprising computer program instructions defining the step of storing a typeprint for said individual of interest.

13. The computer readable medium of claim 11 wherein said recording usage data further comprises the step of storing data related to when said individual of interest logs onto a computer and when said individual of interest logs off of said computer.

14. The computer readable medium of claim 11 further comprising computer program instructions defining the step of obtaining at least one physical characteristic of said user.

15. The computer readable medium of claim 14 further comprising computer program instructions defining the step of comparing said at least one physical characteristic with at least one stored physical characteristic.
